(19) United States
(12) Patent Application Publication
(10) Pub. No.: US 2026/0147167 A1
(43) Pub. Date: May 28, 2026

(54) Optical Module and Optical Receptacle

(71) Applicant: Enplas Corporation, Kawaguchi-shi (JP)

(72) Inventors: Ayano HINATA, Kawaguchi-shi (JP); Takahiro IWASAKI, Kawaguchi-shi (JP)

(21) Appl. No.: 19/400,029

(22) Filed: Nov. 25, 2025

(30) Foreign Application Priority Data
Nov. 27, 2024 (JP) 2024-206755
Oct. 16, 2025 (JP) 2025-175006

(51) Int. Cl. G02B 6/42

(52) U.S. Cl. CPC G02B 6/4214; G02B 6/4286

(57) ABSTRACT

[Problem] To provide an optical receptacle that can further reduce feedback light that reaches a light-emitting element.

[Solution] An optical module including an optical transmission body, a light-receiving element, and an optical receptacle that is arranged between the optical transmission body and the light-receiving element and allows reception light emitted from an end face of the optical transmission body to enter the light-receiving element, wherein the optical receptacle includes a first optical section facing the end face of the optical transmission body and a second optical section facing the light-receiving element, the second optical section includes a second lens surface that focuses the reception light emitted from the end face of the optical transmission body and entering the optical receptacle via the first optical section onto the light-receiving element, the second lens surface is arranged such that a central axis of the second lens surface does not coincide with an optical axis of the reception light, and the second optical section further includes a feedback light suppression area on at least a part of an area where feedback light generated by reflecting the reception light by the light-receiving element is incident, the feedback light suppression area being shaped such that at least a portion of the feedback light does not reach the first optical section.

### CROSS-REFERENCE TO RELATED APPLICATIONS

This application claims the benefit to Japanese Patent Application No. 2025-175006, filed on Oct. 16, 2025, and to Japanese Patent Application No. 2024-206755, filed on Nov. 27, 2024, the entirety of which are incorporated by reference herein.

### BACKGROUND OF THE INVENTION

### Technical Field

The present invention relates to an optical module including a photoelectric conversion element, an optical transmission body, and an optical receptacle for optically coupling the photoelectric conversion element with the optical transmission body, as well as an optical receptacle used therefor.

### Background Art

Conventionally, optical modules equipped with a light-emitting element (optical elements) such as a surface emitting laser (e.g., VCSEL: Vertical Cavity Surface Emitting Laser) or a light-receiving elements (optical elements) have been used for optical communications using optical transmission bodies such as optical fibers and optical waveguides. The optical module has an optical receptacle (optical socket) that allows light (transmission light) containing communication information emitted from the light-emitting element to enter an end face of the optical transmission body (e.g., optical fiber) or allows light (reception light) containing communication information propagated from the end face of the optical transmission body to enter the light-receiving element. Thus, the optical receptacle is an optical coupling element that optically couples the optical element with the optical transmission body.

The optical receptacle has a lens surface formed on a surface facing the end face of the optical transmission body or a surface facing the light-emitting element or light-receiving element, which focuses light onto the end face of the optical transmission body or the light-emitting element or light-receiving element. However, if the central axis of the lens surface coincides with the optical axis, a portion of incident light will be reflected by the end face of the optical transmission body or by the light-receiving element (e.g., a light-receiving surface of the light-receiving element, a surface of a lens formed on a surface of the light-receiving element, etc.) and reach the light-emitting element as feedback light. If the feedback light reaches a light-emitting surface of the light-emitting element, there is a risk of fluctuation in the output of the light emitted from the light-emitting element.

Patent Literature 1 discloses a method for avoiding feedback light in an optical receptacle that allows a portion of laser light emitted from a light-emitting element to enter a light-receiving element as monitoring light, in which optical receptacle a division reflection surface for reflecting a portion of the laser light toward the light-receiving element, and a lens surface for emitting the division and reflected laser light towards the light-receiving element are formed, wherein, in order to prevent the feedback light reflected by the light-receiving element from reaching the light-emitting element, the division reflection surface directing the light toward the light-receiving element is set at an angle different from a predetermined inclination angle (45°), or in addition, an optical axis of the lens surface is set at an angle different from the normal, thereby guiding the feedback light away from the light-emitting element.

### CITATION LIST

### Patent Literature

### [PTL 1]

Japanese Unexamined Patent Application Publication No. 2015-179125

### SUMMARY OF INVENTION

The optical receptacle disclosed in Patent Literature 1 has a light separation section formed by combining three surfaces: the division reflection surface, a division transmission surface, and a step surface, in order to use a portion of the laser light as monitoring light, and avoids feedback light by setting the division reflection surface at an angle different from the predetermined inclination angle. As such, the light separation section with a special structure was indispensable to the means for avoiding feedback light in Patent Literature 1. In the case of a usual reflection surface rather than the aforementioned division reflection surface in the light separation section, by misaligning an optical axis of reception light with a central axis of the lens surface, it was possible to allow the light to enter the light-receiving element obliquely and thus remove a portion of the feedback light reflected by the light-receiving element. However, another portion of the feedback light returns to the light-emitting element, so it was not possible to sufficiently reduce the feedback light.

FIGS. 11A to 11D are views for explaining the problems, in which: FIG. 11A is a schematic cross-sectional view of an example of an optical module 910 in which an optical axis of reception light is misaligned with an central axis of a lens surface in order to allow the light to enter a light-receiving element obliquely; FIG. 11B is a view showing a position on a second lens surface of an optical receptacle 940 of the optical module 910 through which light passes; FIG. 11C is a schematic cross-sectional view of another example of the optical module YO, and FIG. 11D is a view showing a position on a second lens surface of an optical module 911 where light is incident. The optical modules 910 and 911 are both optical modules for receiving light, have an optical transmission body 920, a light-receiving element 930, and the optical receptacle 940, and are connected to the light-receiving element 930 with the optical transmission body 920 being connected to the optical receptacle 940. The optical receptacle 940 has a first lens surface 941a formed on a first optical section 941 facing an end face 921 of the optical transmission body 920, a second lens surface 942a formed on a second optical section 942 facing the light-receiving element 930, and a reflection surface 943 formed therebetween. The first lens surface 941a is arranged such that its central axis CA1 (dashed dotted line) is inclined relative to a central axis CA3 (dashed double-dotted line) of the optical transmission body 920, and an optical axis LO1 of the reception light L1 emitted from the end face 921 of the optical transmission body 920 obliquely enters the first lens surface 941a at a position above the central axis CA1. The second lens surface 942a is arranged such that its central axis CA2 (dashed dotted line) coincides with a central axis CA4 (dashed double-dotted line) of the light-receiving element 930.

In the arrangement shown in FIG. 11A, the luminous flux of the reception light L1 emitted from the end face 921 of the optical transmission body 920 enters the optical receptacle as parallel light due to the action of the first lens surface 941a; is reflected by the reflection surface 943 toward the second optical section 942; enters, as shown in FIG. 11B, the second lens surface 942a at a position to the right of the central axis CA2 in the drawing; and illuminates the light-receiving element 930 obliquely from the right due to the action of the second lens surface 942a. The luminous flux of the feedback light L2 (dashed line) reflected by the light-receiving element 930 travels obliquely upward to the left from the light-receiving element 930; enters, as shown in FIG. 11B, the second lens surface 942a at a position to the left of the central axis CA2 in the drawing; enters the optical receptacle as parallel light due to the action of the second lens surface 942a; and is reflected by the reflection surface 943 toward the first optical section 941; and then, a portion of the light enters the first lens surface 941a and reaches the light-emitting element via the end face 921 of the optical transmission body 920.

In the arrangement shown in FIG. 11C, the luminous flux of the reception light L1 emitted from the end face 921 of the optical transmission body 920 enters, as shown in FIG. 11D, the second lens surface 942a at a position to the left of the central axis CA2 in the drawing; and illuminates the light-receiving element 930 obliquely from the left due to the action of the second lens surface 942a. The luminous flux of the feedback light L2 (dashed line) reflected by the light-receiving element 930 travels obliquely upward to the right from the light-receiving element 930; enters, as shown in FIG. 11D, the second lens surface 942a at a position to the right of the central axis CA2 in the drawing; enters the optical receptacle as parallel light due to the action of the second lens surface 942a; is reflected by the reflection surface 943 toward the first optical section 941; enters the first lens surface 941a and converges on the end face 921 of the optical transmission body 920. A portion of the feedback light can be eliminated by the incident NA angle of the end face 921 of the optical transmission body 920, but another portion thereof still reaches the light-emitting element via the optical transmission body 920. It should be noted that, although not shown, an optical module for transmission also suffer from the following similar problem: when allowing transmission light emitted from a light-emitting element via an optical receptacle to enter an end face of an optical transmission body, feedback light is generated due to reflection of a portion of the transmission light by an end body of the optical transmission body and reaches the light-emitting element via the optical receptacle.

An object of the present invention is to provide an optical receptacle and an optical module that can further reduce feedback light that reaches a light-emitting element as described above.

To solve the aforementioned problems, an optical module according to the present invention is an optical module including an optical transmission body, a light-receiving element, and an optical receptacle that is arranged between the optical transmission body and the light-receiving element and allows reception light emitted from an end face of the optical transmission body to enter the light-receiving element, in which
the optical receptacle includes a first optical section facing the end face of the optical transmission body and a second optical section facing the light-receiving element,
the second optical section includes a second lens surface that focuses the reception light that emitted from the end face of the optical transmission body and entering the optical receptacle via the first optical section onto the light-receiving element,
the second lens surface is arranged such that a central axis of the second lens surface does not coincide with an optical axis of the reception light, and
the second optical section further includes a feedback light suppression area on at least a part of an area where feedback light generated by reflecting the reception light by the light-receiving element is incident, the feedback light suppression area being shaped such that at least a portion of the feedback light does not reach the first optical section.

Furthermore, in the aforementioned optical module, the feedback light suppression area may include: a plane that is inclined relative to a plane orthogonal to the central axis of the light-receiving element at an inclination such that an optical path length of an optical axis of the feedback light from the light-receiving element to the second optical section is shorter than an optical path length of the optical axis of the reception light from the second optical section to the light-receiving element; or a curved surface by which the optical path length of the optical axis of the feedback light from the light-receiving element to the second optical section is shorter than the optical path length of the optical axis of the reception light from the second optical section to the light-receiving element. In addition, the feedback light suppression area may include a plane perpendicular to the central axis of the light-receiving element.

In addition, another optical module according to the present invention is an optical module including an optical transmission body, a light-receiving element, and an optical receptacle that is arranged between the optical transmission body and the light-receiving element and allows reception light emitted from an end face of the optical transmission body to enter the light-receiving element, in which
the optical receptacle includes a first optical section facing the end face of the optical transmission body and a second optical section facing the light-receiving element,
the second optical section includes a second lens surface that focuses the reception light emitted from the end face of the optical transmission body and entering the optical receptacle via the first optical section onto the light-receiving element, and an inclined surface inclined relative to a plane orthogonal to a central axis of the light-receiving element,
the second lens surface is arranged such that a central axis of the second lens surface does not coincide with an optical axis of the reception light,
the inclined surface has an inclination such that, in a cross section including the central axis of the light-receiving element and the optical axis, it is closer to the light-receiving element at a point farther away from the central axis of the second lens surface in a direction opposite to the optical axis relative to the central axis of the second lens surface, and
at least a portion of the second lens surface is continuous with the inclined surface.

Furthermore, in the aforementioned optical module, the second optical section further includes a plane perpendicular to the central axis of the light-receiving element, and a portion of the second lens surface may be continuous with the perpendicular plane.

In addition, another optical module according to the present invention is an optical module including an optical transmission body, a light-receiving element, and an optical receptacle that is arranged between the optical transmission body and the light-receiving element and allows reception light emitted from an end face of the optical transmission body to enter the light-receiving element, in which
the optical receptacle includes a first optical section facing the end face of the optical transmission body and a second optical section facing the light-receiving element,
the first optical section includes a first lens surface that allows the reception light emitted from the end face of the optical transmission body to enter the optical receptacle,
the second optical section includes a second lens surface that focuses the reception light entering the optical receptacle via the first lens surface onto the light-receiving element,
the second lens surface is arranged such that a central axis of the second lens surface does not coincide with an optical axis of the reception light, and
the first optical section further includes a feedback light suppression area on at least a part of an area from which feedback light generated by reflecting the reception light by the light-receiving element is emitted, the feedback light suppression area being shaped such that at least a portion of the feedback light does not reach the end face of the optical transmission body.

Furthermore, in the aforementioned optical module, the feedback light suppression area may include: a plane that is inclined relative to a plane orthogonal to the central axis of the optical transmission body at an inclination such that an optical path length of the feedback light from the light-receiving element to the first optical section is longer than an optical path length of the reception light from the first optical section to the light-receiving element; or a curved surface by which the optical path length of the feedback light from the light-receiving element to the first optical section is longer than the optical path length of the reception light from the first optical section to the light-receiving element. In addition, the feedback light suppression area may include: a plane that is inclined relative to a plane orthogonal to the central axis of the optical transmission body at an inclination such that, in a cross section including the central axis of the optical transmission body and the optical axis of the feedback light, it is closer to the end face of the optical transmission body at a point farther away from the central axis of the first lens surface in a direction toward the optical axis of the feedback light relative to the central axis of the first lens surface; or a curved surface which, in a cross section including the central axis of the optical transmission body and the optical axis of the feedback light, is closer to the end face of the optical transmission body at a point farther away from the central axis of the first lens surface in the direction toward the optical axis of the feedback light relative to the central axis of the first lens surface.

In addition, another optical module according to the present invention is an optical module including an optical transmission body, a light-emitting element, and an optical receptacle that allows transmission light emitted from the light-emitting element to enter an end face of the optical transmission body, in which
the optical receptacle includes a first optical section facing the end face of the optical transmission body and a second optical section facing the light-emitting element,
the first optical section includes a first lens surface that allows the transmission light emitted from the light-emitting element and entering the optical receptacle via the second optical section to enter the end face of the optical transmission body,
the first lens surface is arranged such that a central axis of the first lens surface does not coincide with an optical axis of the transmission light, and
the first optical section further includes a feedback light suppression area on at least a part of an area where feedback light generated by reflecting the transmission light by the end face of the optical transmission body is incident, the feedback light suppression area being shaped such that at least a portion of the feedback light does not reach the light-emitting element.

Furthermore, in the aforementioned optical module, the feedback light suppression area may include: a plane that is inclined relative to a plane orthogonal to the central axis of the optical transmission body at an inclination such that an optical path length of the feedback light from the end face of the optical transmission body to the first optical section is shorter than an optical path length of the transmission light from the first optical section to the end face of the optical transmission body; or a curved surface by which the optical path length of the feedback light from the end face of the optical transmission body to the first optical section is shorter than the optical path length of the transmission light from the first optical section to the end face of the optical transmission body.

Furthermore, in the aforementioned optical module, the feedback light suppression area may be an area that refracts light away from the central axis of the optical transmission body. In addition, the first optical section further includes a second surface different from the inclined plane or curved surface, the second surface being perpendicular to the central axis of the first lens surface, perpendicular to the central axis of the optical transmission body, or inclined at an inclination opposite to the inclined plane or curved surface, and a portion of the first lens surface may be continuous with the second surface.

In addition, an optical receptacle according to the present invention is an optical receptacle used in the aforementioned optical module.

### Advantageous Effects of Invention

The optical module of the present invention, in which the second lens surface is arranged such that the central axis of the second lens surface does not coincide with the central axis of the reception light, can separate the optical path of the reception light from the optical path of the feedback light, and furthermore, includes the feedback light suppression area on at least a part of the area of the second optical section where the feedback light is incident, so that at least a portion of the feedback light does not reach the first optical section, thereby further reducing the amount of the feedback light that reaches the light-emitting element. In addition, the optical module of the present invention, in which the second lens surface is arranged such that the central axis of the second lens surface does not coincide with the central axis of the reception light, can separate the optical path of the reception light from the optical path of the feedback light, the second optical section further includes the second lens surface and the inclined surface inclined relative to the plane orthogonal to the central axis of the light-receiving element, the inclined surface has an inclination such that, in a cross section including the central axis of the light-receiving element and the optical axis, it is closer to the light-receiving element at a point farther away from the central axis of the second lens surface in a direction opposite to the optical axis relative to the central axis of the second lens surface, and at least a portion of the second lens surface is continuous with the inclined surface, so that at least a portion of the feedback light entered the inclined surface follows an optical path different from that of the reception light and does not reach the end face of the optical transmission body, and thus can be prevented from reaching the light-emitting element.

The optical module of the present invention, in which the second lens surface is arranged such that the central axis of the second lens surface does not coincide with the central axis of the reception light, can separate the optical path of the reception light from the optical path of the feedback light, and furthermore, the first optical section further includes a feedback light suppression area on at least a part of an area from which feedback light generated by reflecting the reception light by the light-receiving element is emitted, the feedback light suppression area being shaped such that at least a portion of the feedback light does not reach the end face of the optical transmission body, so that at least a portion of the feedback light does not reach the end face of the optical transmission body, thereby further reducing the amount of the feedback light that reaches the light-emitting element.

In addition, the optical module of the present invention, in which the first lens surface is arranged such that the central axis of the first lens surface does not coincide with the central axis of the transmission light, can separate the optical path of the transmission light from the optical path of the feedback light, and furthermore, the feedback light suppression area is provided on at least a part of the area of the first optical section where the feedback light is incident, so that at least a portion of the feedback light of the transmission light does not reach the light-emitting element, thereby further reducing the amount of the feedback light that reaches the light-emitting element. Other effects will be described in Description of Embodiments.

### BRIEF DESCRIPTION OF THE DRAWINGS

FIG. 1A is a schematic configuration view of an optical module and an optical receptacle according to a first embodiment of the present invention, and FIG. 1B is a view showing positions on a second optical section of the optical receptacle through which light passes.

FIGS. 2A to 2E are views from six sides of an optical receptacle 40, in which FIG. 2A is a plan view, FIG. 2B is a front view, FIG. 2C is a bottom view, FIG. 2D is a rear view, and FIG. 2E is a side view (same for left and right).

FIGS. 3A, 3B, and 3C are views for illustrating a shape of a second lens surface.

FIG. 4A is a schematic configuration view of another optical module and another optical receptacle according to the first embodiment of the present invention, and FIG. 4B is a view showing positions on a second optical section of the optical receptacle through which light passes.

FIG. 5A is a schematic configuration view of another optical module and another optical receptacle according to the first embodiment of the present invention, FIG. 5B is an enlarged view of a second optical section of the optical receptacle, and FIG. 5C is a reference view in which an inclined surface is extended.

FIG. 6 FIG. 6A is a schematic configuration view of an optical module and an optical receptacle according to a second embodiment of the present invention, and FIGS. 6B and 6C are views for illustrating the shape of a first lens surface.

FIG. 7 is a schematic configuration view of another optical module and another optical receptacle according to the second embodiment of the present invention.

FIG. 8 is a schematic configuration view of another optical module and another optical receptacle according to the second embodiment of the present invention.

FIG. 9 is a schematic configuration view of another optical module and another optical receptacle according to the second embodiment of the present invention.

FIG. 10 is a schematic configuration view of an optical module and an optical receptacle according to a third embodiment of the present invention.

FIG. 11

FIGS. 11A to 11D are views for explaining problems of optical modules, in which FIGS. 11A and 11C are schematic cross-sectional views of an example of the optical module, and FIGS. 11B and 11D are views showing a position on a second lens surface through which light passes.

### DETAILED DESCRIPTION OF THE INVENTION

### Summary of Invention

The optical receptacle and the optical module according to the present invention are configured such that the central axis of the first lens surface and/or the central axis of the second lens surface are arranged so as not to coincide with the optical axis of the reception light or the transmission light, thereby separating the optical path of the reception light or the transmission light from the optical path of its feedback light so as not to overlap at least partially, and the feedback light suppression area is formed on an area on the first optical section or the second optical section through which only the feedback light passes, thereby suppressing the feedback light from returning to the light-emitting element. Now, a first embodiment in which a feedback light suppression area is formed on a second optical section in a receiving optical module, a second embodiment in which a feedback light suppression area is formed on a first optical section in a receiving optical module, and a third embodiment in which a feedback light suppression area is formed on a first optical section in a transmitting optical module will be described with reference to the drawings. However, the present invention is not limited thereto and can be modified in various ways without impairing the characteristic of the present invention.

### First Embodiment

### Embodiment 1-1

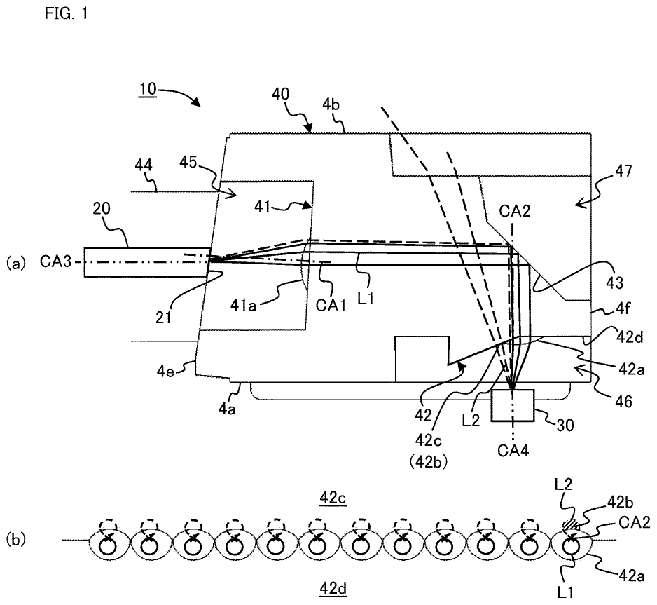

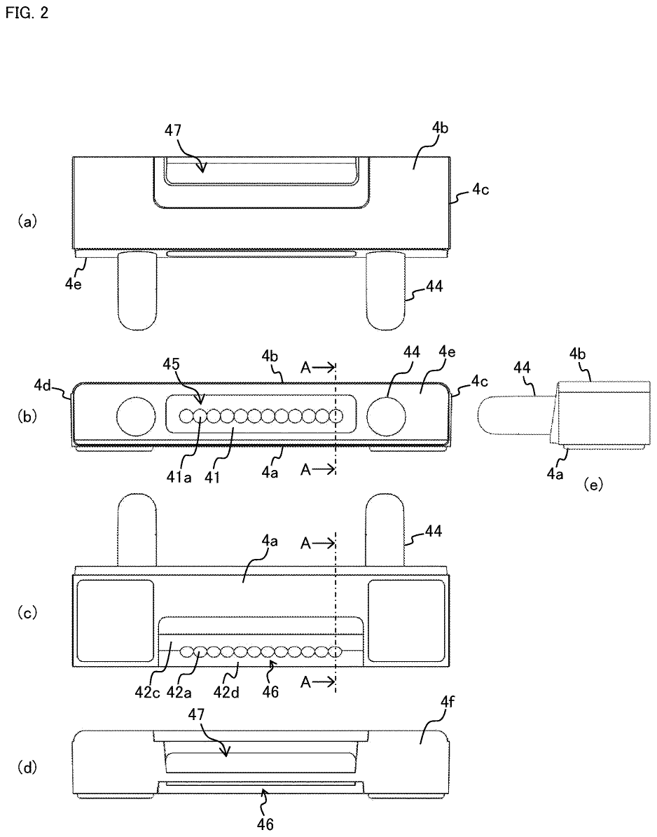

FIG. 1A is a schematic configuration view that shows an overview of an optical module 10 according to a first embodiment of the present invention along with a longitudinal cross-sectional view of an optical receptacle 40 according to this embodiment (corresponding to a cross sectional view taken along a line A-A in FIG. 2C), and FIG. 1B is a view showing positions on a second optical section 42 of the optical receptacle 40 of the optical module 10 through which light passes. FIGS. 2A to 2E are views from six sides of the optical receptacle 40, in which FIG. 2A is a plan view, FIG. 2B is a front view, FIG. 2C is a bottom view, FIG. 2D is a rear view, and FIG. 2E is a side view (same for left and right).

As shown in FIG. 1A, the optical module 10 is configured as follows: it includes an optical transmission body 20, a light-receiving element 30, and the optical receptacle 40; the optical receptacle 40 is arranged between the optical transmission body 20 and the light-receiving element 30; it allows reception light L1 emitted from an end face 21 of the optical transmission body 20 to enter the optical receptacle 40 via a first optical section 41 of the optical receptacle 40; and it allows the reception light that has traveled through the optical receptacle 40 to enter the light-receiving element 30 via a second optical section 42. The optical module of the first embodiment is implemented in a receiving section of a receiving optical module or a transmitting/receiving optical module.

The optical transmission body 20 is a medium or structure for transmitting optical signals, and its type is not particularly limited and includes an optical fiber, an optical waveguide, and the like. In this embodiment, the reception light L1 that has been transmitted via the optical transmission body 20 is emitted from the end face 21. The optical fiber may be a single-mode optical fiber or a multimode optical fiber. The number of the optical transmission bodies is not particularly limited and is selected according to the configuration of the optical receptacle 40. In this embodiment, 12 optical fibers corresponding to 12 first lens surfaces 41a shown in FIG. 2B are arranged in a row at regular intervals. It should be noted that the optical transmission bodies 20 may be arranged in two or more rows. The end of the optical transmission body may be held by a ferrule not shown in order to position the end face of the optical transmission body relative to the first optical section 41 of the optical receptacle 40. A through-hole (not shown) corresponding to a ferrule-matching convex part 44 on the optical receptacle may be formed on the ferrule. The ferrule-matching convex part 44 on the optical receptacle 40 can be fitted into the through-hole provided on the ferrule in order to position the end face of the optical transmission body relative to the optical receptacle 40. Alternatively, the end of the optical transmission body may be held by a holding shape integrally in order to position the end face of the optical transmission body relative to the first optical section of the optical receptacle.

A direction of the optical axis of the reception light L1 emitted from the end face of the end face 21 of the optical transmission body 20 can be appropriately set by an emission angle from the end face 21 and positioning relative to the optical receptacle 40. In FIG. 1A, the reception light L1 is emitted obliquely upward relative to a central axis CA3 (dashed double-dotted line) of the optical transmission body 20 and is incident obliquely above the central axis CA1 of the first lens surface. However, in this embodiment, since a feedback light suppression area is formed on the second optical section of the optical receptacle 40, an angle of the reception light emitted from the end face 21, an angle of the reception light entering the first optical section, etc., are not particularly limited. For example, the central axis CA3 (dashed double-dotted line) of the optical transmission body 20 may coincide with the optical axis of the reception light, or the optical axis of the reception light may coincide with the central axis CA1 of the first lens surface. It should be noted that the central axis CA3 of the optical transmission body refers to an axis of a cylindrical core of the optical transmission body and does not necessarily coincide with the normal to the end face of the optical transmission body.

The light-receiving element 30 receives the reception light L1 emitted from the end face 21 of the optical transmission body 20. The light-receiving element 30 is, for example, a photodetector. The number of the light-receiving element 30 is not particularly limited and selected according to the configuration of the optical receptacle 40. In this embodiment, the number of the light-receiving element 30 is 12 as shown in FIG. 1B and FIG. 2C, but is not particularly limited and may be, for example, 4. The light-receiving element 30 may be implemented on a substrate not shown. A central axis CA4 of the light-receiving element 30 may be arranged to be parallel to the normal to the surface of the substrate, or to be inclined relative to the normal. For ease of installation and alignment with the optical receptacle, it is preferable to the central axis CA4 of the light-receiving element 30 is arranged to be parallel to the normal to the surface of the substrate. It should be noted that the central axis CA4 of the light-receiving element 30 refers to the normal to a light-receiving surface of the light-receiving element 30 passing through the center of the light-receiving surface.

The central axis CA4 of the light-receiving element 30 may be arranged to be parallel to a central axis CA2 of a second lens surface 42a of the second optical section 42 of the optical receptacle 40, or to be inclined relative to the central axis CA2. In order to prevent deformation of the beam shape of the reception light on the light-receiving element 30, etc., it is preferable that the central axis CA4 of the light-receiving element 30 is arranged to be parallel to the central axis CA2 of the second lens surface 42a, and the central axis CA4 of the light-receiving element 30 may coincide with the central axis CA2 of the second lens surface 42a.

The optical receptacle 40 of this embodiment has a function of emitting the reception light L1 emitted from the optical transmission body 20 toward the light-receiving surface of the light-receiving element 30. The external shape of the optical receptacle 40 is not limited as long as it can perform such a function, and it may be, for example, a substantially rectangular parallelepiped member as shown in FIGS. 2A to 2E. That is, the external shape of the main part of the optical receptacle 40 is generally configured by a bottom surface 4a, a top surface 4b, side surfaces 4c and 4d, a front surface 4e, and a rear surface 4f. The bottom surface 4a and the top surface 4b are arranged to be parallel to each other, the two side surfaces 4c and 4d are also arranged to be parallel to each other, and the front surface 4e and the rear surface 4f are also arranged to be parallel to each other. Furthermore, adjacent surfaces are perpendicular to each other. A ferrule-matching convex part 44 may also be provided protruding from the front surface of the optical receptacle 40. However, the configuration is not necessarily limited thereto, and for example, when the optical receptacle 40 is molded from resin, a release taper for release from a mold may be formed on one of the surfaces.

The optical receptacle 40 has at least the first optical section 41 arranged on the front surface 4e side and the second optical section 42 arranged on the bottom surface 4a side. Furthermore, in this embodiment, it has a reflection surface 43 and the ferrule-matching convex part 44. As shown in FIG. 1, a first recess 45 is formed on the front surface 4e of the optical receptacle 40, and the inner bottom surface (the right surface in the drawings) of the first recess 45 functions as the first optical section 41. In addition, a second recess 46 is formed on the bottom surface 4a and the rear surface 4f of the optical receptacle 40, and the ceiling surface of the second recess 46 functions as the second optical section 42. Furthermore, a third recess 47 is formed on the top surface 4b and the rear surface 4f of the optical receptacle 40, and an inner inclined surface, which is inclined leftward toward the top of the third recess 47, functions as the reflection surface 43. The optical receptacle 40 is formed of a material that is transparent in the wavelength range of light used in the optical module 10. Examples of such materials include transparent resins such as polyetherimide (PEI) and cyclic olefin resin.

The first optical section 41 faces the end face 21 of the optical transmission body 20 and has an optical surface that allows the reception light emitted from the end face 21 of the optical transmission body 20 to enter the inside of the optical receptacle. The shape of the optical surface of the first optical section 41 is not particularly limited and may be a convex lens surface that is convex toward the end face 21 of the optical transmission body 20, a concave lens surface that is concave toward the end face 21 of the optical transmission body 20, or a plane. In this embodiment, the first optical section 41 has a first lens surface 41a that is convex toward the end face 21 of the optical transmission body 20. The planar shape of the first lens surface 41a is not particularly limited and may be a circular shape or an elliptical shape. In this embodiment, the planar shape of the first lens surface 41a is a circular shape. The number and the arrangement of the first lens surface 41a correspond to those of the optical transmission body 20, and in this embodiment, 12 first lens surfaces are arranged in a row at regular intervals as shown in FIG. 2B. The first lens surface 41a allows the reception light L1 emitted from the end face 21 of the optical transmission body 20 to enter the inside of the optical receptacle as parallel light. In this embodiment, the central axis CA1 of the first lens surface may or may not coincide with the optical axis of the reception light L1.

The second optical section 42 includes the second lens surface 42a that focuses the reception light L1 emitted from the end face 21 of the optical transmission body 20 and entering the optical receptacle via the first optical section 41 onto the light-receiving element 30, and the feedback light suppression area 42b on at least a part of an area where the feedback light L2 generated by reflecting the reception light L1 by the light-receiving element 30 is incident, the feedback light suppression area 42b being shaped such that at least a portion of the feedback light L2 does not reach the first optical section 41. The number and the arrangement of the second lens surface 42a correspond to those of the light-receiving element 30, and in this embodiment, 12 second lens surfaces are arranged in a row at regular intervals as shown in FIG. 1B and FIG. 2C. The reception light L1 traveling through the optical receptacle enters the second lens surface 42a, and it refracts and emits the reception light L1 toward the light-receiving element 30. In this embodiment, the second lens surface 42a is arranged such that the central axis CA2 of the second lens surface does not coincide with the optical axis of the reception light L1. Specifically, the central axis CA2 of the second lens surface 42a is arranged to be inclined relative to the optical axis of the reception light L1 or is arranged such that the central axis CA2 of the second lens surface 42a is parallel to but does not coincide with the optical axis of the reception light L1.

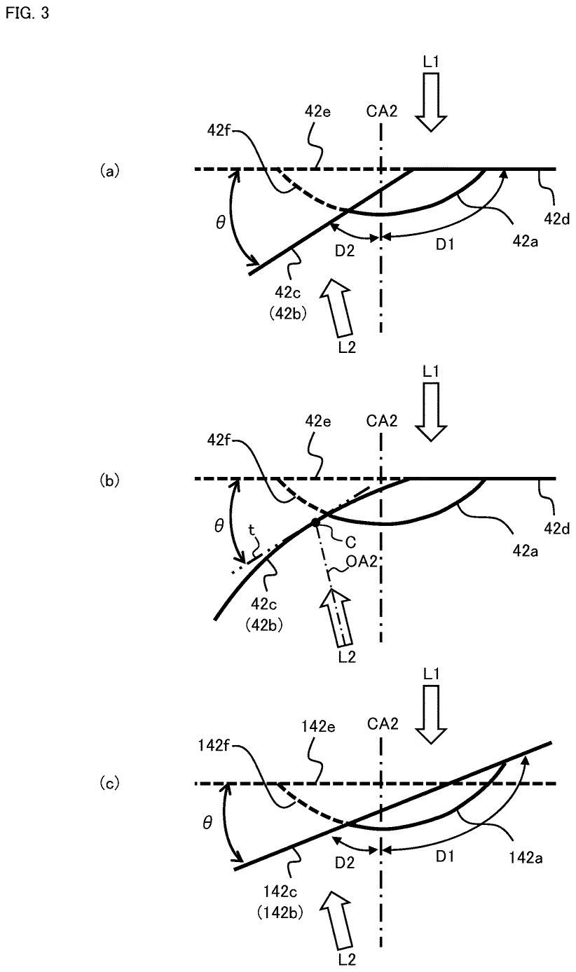

FIG. 3A is a view for illustrating a shape of the second lens surface 42a according to this embodiment. Conventionally, the second optical section has the lens surface (solid line curved surface 41a and dotted line curved surface 41f) that is symmetrical relative to the central axis of the lens surface on flat base surfaces 42d and 42e (dotted line) perpendicular to the central axis CA2 of the lens surface and/or the central axis CA4 of the light-receiving element 30. In contrast, the second optical section 42 of this embodiment has the same curved second lens surface 42a as the conventional one on the same flat base surface 42d as the conventional one and an inclined base surface 42c that is inclined from the base surface by an angle θ (an angle of 90°-θ relative to the central axis CA2 of the second lens surface 42a). As shown in FIG. 3A, the second lens surface 42a of this embodiment is the same curved surface as the conventional one, and its central axis CA2 is also the same as the central axis of the conventional lens surface. The second lens surface 42a is integrally formed with the flat base surface 42d and the inclined base surface 42c and is continuous with the flat base surface 42d and the inclined base surface 42c. The second lens surface formed to be continuous with the flat base surface 42d has the same three-dimensional shape as the conventional one, but the portion formed on the inclined base surface 42c when viewed from the side has a shape obtained by cutting the conventional lens surface along the inclined base surface 42c. Therefore, in a cross section including the central axis of the second lens surface and the optical axis of the reception light, the second lens surface 42a becomes asymmetric relative to the central axis CA2 of the second lens surface 42a so that a length D2 of the curved surface on the opposite side to the optical axis of the reception light L1 relative to the central axis CA2 (in a direction in which the feedback light L2 is incident) is shorter than a length D1 of the curved surface on the side of the optical axis of the reception light L1 relative to the central axis CA2. The central axis CA2 of the second lens surface 42a refers to, for example, the central axis of the second lens surface when the base surface of the lens is not inclined in a cross section of the second optical section obtained by cutting it along a plane orthogonal to the central axis of the light-receiving element.

The inclined base surface 42c is an inclined surface (plane or curved surface) inclined relative to a plane orthogonal to the central axis CA4 of the light-receiving element 30 and has an inclination such that an optical path length of the optical axis of the feedback light L2 from the light-receiving element 30 to the second optical section 42 is shorter than an optical path length of the optical axis of the reception light L1 from the second optical section 42 to the light-receiving element 30. In addition, the inclined base surface 42c is inclined such that, in a cross section including the central axis of the second lens surface and the optical axis of the reception light, it is closer to the light-receiving element 30 at a point farther away from the central axis CA2 of the second lens surface 42a in a direction opposite to the optical axis of the reception light L1. An area of the inclined base surface 42c where the feedback light L2 is incident functions as the feedback light suppression area 42b. In this embodiment, the plane inclined by an angle θ relative to the base surface 42 d is the feedback light suppression area 42 b. The angle θ of the inclined base surface 42 c can be from 10° to 90°. The base surface 42 d is a plane perpendicular to the central axis CA2 of the lens surface and/or the central axis CA4 of the light-receiving element 30. It should be noted that, although it is designed to be perpendicular, it may be slightly inclined in actual manufacturing and can be inclined with a tolerance of ±3° (the same applies to other perpendicular surfaces). In addition, if the inclined base surface 42c (and the feedback light suppression area 42b) is a curved surface, in the a longitudinal cross-sectional view shown in FIG. 3B, the tangent t of the curved surface at a point C where the optical axis OA of the feedback light L2 intersects with the curved inclined base surface 42c is inclined relative to the base surface 42d, and the angle of the tangent t is the inclination θ (the same applies to other inclined surfaces). Although the inclined base surface 42c is a concave surface in FIG. 3B, it may also be a convex surface. It should be noted that although FIG. 1A and FIG. 3A are cross-sectional views, the position of the base surface within the lens is also shown in order to make it easier to understand the relationship between the second lens surface and the base surface (the same applies to other cross-sectional views).

FIG. 1B is a plan view of the second optical section 42 as viewed from a direction of the central axis CA4 of the light-receiving element 30 and shows an area L1 (solid line) of the reception light passing through the second optical section 42 and an area L2 (dashed line) of the feedback light. The bottom of the drawing shows the flat base surface 42d, and the top of the drawing shows the inclined base surface 42c. The planar shape of the second lens surface 42a is not particularly limited and may be designed as a circular shape or an elliptical shape. However, while the planar shape of the second lens surface on the flat base surface 42d will be as designed, the planar shape of the second lens surface on the inclined base surface 42c will be a shape obtained by cutting out the designed shape along the inclined base surface 42c. As shown in FIG. 1B, the entire reception light L1 passes through the second lens surface 42a, but a portion of the feedback light L2 passes through the second lens surface 42a and the rest passes through the inclined base surface 42c. An area of the inclined base surface 42c through which the feedback light L2 passes is the feedback light suppression area 42b according to this embodiment.

Since the second optical section of this embodiment 42 has the flat base surface 42d and thus can secure a thick portion (a portion between the second recess 46 and the third recess 47) on the rear surface side, it is possible to set the inclination angle θ of the inclined base surface 42c larger than in Embodiment 1-2 described below.

The reflection surface 43 is an inclined surface formed on the top surface side of the optical receptacle 40 and is arranged on the optical path between the first optical section 41 and the second optical section 42. The reflection surface 43 is configured to be able to internally reflect the reception light incident from the first optical section 41 toward the second optical section 42. The reflection surface 43 is not necessarily a plane as long as it can reflect light, and for example, it may be a convex mirror having a convex surface, or a concave mirror having a concave surface. In this embodiment, the reflection surface 43 is a plane that is inclined at a certain inclination angle so as to approach the first optical section 42 from the bottom surface to the top surface of the optical receptacle 40. The inclination angle of the reflection surface 43 can be appropriately set according to the optical path of the light emitted from the optical transmission body 20 and the position of the light-receiving surface of the light-receiving element 30.

The ferrule-matching convex part 44 is fitted into the through hole or the like provided in the ferrule. The ferrule not shown holds the end of the optical transmission body and positions the end face of the optical transmission body relative to the first optical section 41 of the optical receptacle 40, and it is configured to be detachable from the optical receptacle 40. A through-hole (not shown) corresponding to a ferrule-matching convex part 44 of the optical receptacle is formed on the ferrule 40. The ferrule-matching convex part 44 of the optical receptacle 40 is fitted into the through hole provided on the ferrule in order to position the end face of the optical transmission body relative to the optical receptacle 40. The ferrule-matching convex parts 44 are arranged on the front surface of the optical receptacle 40 and on both sides of the first optical section 41. In this embodiment, the ferrule-matching convex part 44 is a convex part having a substantially cylindrical shape. Alternatively, the end of the optical transmission body may be held by a holding shape integrally in order to position the end face of the optical transmission body relative to the first optical section of the optical receptacle.

As shown in FIG. 1A, in the optical module 10 of this embodiment, the reception light L1 obliquely emitted from the end face 21 of the optical transmission body 20 enters the first lens surface 41a of the first optical section 41, travels in the optical receptacle 40 as parallel light, is reflected by the reflection surface 43, enters the second lens surface 42a of the second optical section 42 such that its optical axis is parallel to the central axis CA2 of the second lens surface 42a and does not coincide with the central axis CA2 of the second lens surface 42a, is emitted to converge toward the light-receiving element 30, and enters the light-receiving element 30. The feedback light L2 generated by reflecting the reception light L1 by the surface of the light-receiving element 30 travels while diffusing toward the second optical section, a portion of it passes through the second lens surface 42a, and the rest enters the feedback light suppression area 42b of the inclined base surface 42c. The feedback light entering the feedback light suppression area 42b is refracted according to an incident angle of the feedback light L2, the inclination angle θ, and a refractive index of the optical receptacle 40. Here, since it is inclined such that it is closer to the light-receiving element 30 at a point farther away from the central axis CA2 of the second lens surface 42a in a direction opposite to the optical axis of the reception light L1, it is refracted away from the central axis CA2 of the second lens surface. Thus, the feedback light entering the feedback light suppression area 42b does not reach the reflection surface 43 and is emitted from the top surface 4b of the optical receptacle 40. Therefore, the optical module 10 and the optical receptacle 40 of this embodiment can prevent the feedback light entering the feedback light suppression area 42b from reaching the first optical section 41, can also prevent it from reaching the end face 21 of the optical transmission body 20, and can even prevent it from reaching a light-emitting element not shown via the optical transmission body 20.

### Embodiment 1-2

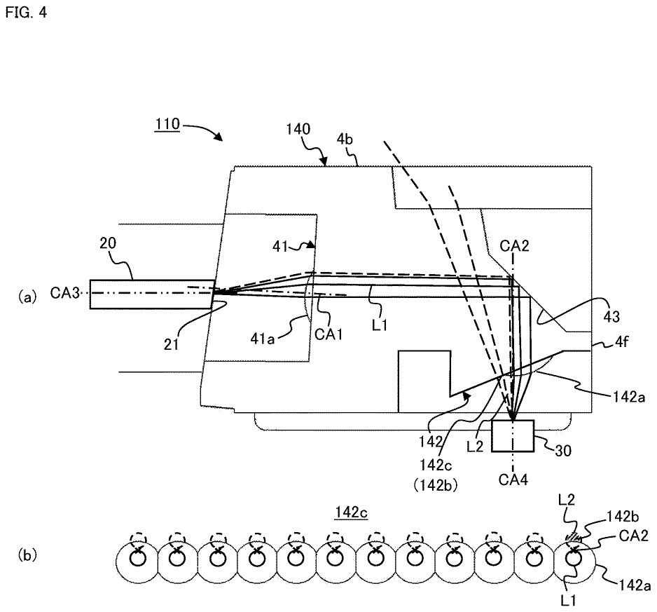

FIG. 4A is a schematic configuration view that shows an overview of another optical module 110 according to the first embodiment of the present invention along with a longitudinal cross-sectional view of an optical receptacle 140 according to this embodiment, and FIG. 4B is a view showing positions on a second optical section 142 of the optical receptacle 140 of the optical module 110 through which light passes. The optical module 110 of this embodiment differs from that of Embodiment 1 -1 only in configuration of a second optical section 142 and is otherwise the same as the optical module 10 of Embodiment 1-1, so a description thereof will be omitted.

As shown in FIG. 4A, the second optical section 142 of this embodiment includes a second lens surface 142a and a feedback light suppression area 142b. FIG. 3C is a view for illustrating a shape of the second lens surface 142a according to this embodiment. In this embodiment, the second lens surface 142a, which is the same curved surface as the conventional one, is formed to be continuous with an inclined base surface 142c inclined by an angle θ (an angle of 90°-θ relative to a central axis CA2 of the second lens surface 142a) from the conventional flat base surface 142e (dotted line). As shown in FIG. 3C, the second lens surface 142a of this embodiment is the same curved surface as the conventional one, and its central axis CA2 is also the same as the central axis of the conventional lens. As shown in FIG. 3C, depending on the angle θ of the inclined base surface 142c, the lens surface may be made to extend further than the conventional lens surface on the right side of the drawing. In a cross section including the central axis CA2 of the second lens surface and the optical axis of the reception light, the second lens surface 142a is asymmetric relative to the central axis CA2 of the second lens surface 142a so that a length D2 of the curved surface on the opposite side to the optical axis of the reception light L1 relative to the central axis CA2 (in a direction in which feedback light L2 is incident) is shorter than a length D1 of the curved surface on the side of an optical axis of reception light L1 relative to the central axis CA2.

The inclined base surface 142c is an inclined surface (plane or curved surface) inclined relative to a plane orthogonal to a central axis CA4 of a light-receiving element 30 and has an inclination such that an optical path length of the optical axis of the feedback light L2 from the light-receiving element 30 to the second optical section 142 is shorter than an optical path length of the optical axis of the reception light L1 from the second optical section 142 to the light-receiving element 30. In addition, the inclined base surface 142c is inclined such that, in a cross section including the central axis of the second lens surface and the optical axis of the reception light, it is closer to the light-receiving element 30 at a point farther away from the central axis CA2 of the second lens surface 142a in a direction opposite to the optical axis of the reception light L1. An area of the inclined base surface 142c where the feedback light L2 is incident functions as the feedback light suppression area 142b. In this embodiment, the plane inclined by an angle 90°-θ (the conventional flat base surface) relative to the central axis CA2 of the second lens surface 142 a is the feedback light suppression area 142 b. The angle θ of the inclined base surface 142 c can be from 10° to 45°.

FIG. 4B is a plan view of the second optical section 142 as viewed from a direction of the central axis CA4 of the light-receiving element 30 and shows an area L1 (solid line) of the reception light passing through the second optical section 142 and an area L2 (dashed line) of the feedback light. An area other than the second lens surface 142a is the inclined base surface 142c. The planar shape of the second lens surface 142a is not particularly limited and may be designed as a circular shape or an elliptical shape. However, the planar shape of the second lens surface on the inclined base surface 142c will be a shape obtained by cutting out the designed shape along the inclined base surface 142c. As shown in FIG. 4B, the entire reception light L1 passes through the second lens surface 142a, but a portion of the feedback light L2 passes through the second lens surface 142a and the rest passes through the inclined base surface 142c. An area of the inclined base surface 142c through which the feedback light L2 passes is the feedback light suppression area 142b according to this embodiment.

In the second optical section 142 of this embodiment, the lens has a nearly circular planar shape, and the lens position can be measured with high precision in the lens arrangement direction so that the lens position can be controlled with high precision.

As shown in FIG. 4A, in the optical module 110 of this embodiment, the reception light L1 obliquely emitted from an end face 21 of an optical transmission body 20 enters a first lens surface 41a of a first optical section 41, travels in the optical receptacle 140 as parallel light, is reflected by a reflection surface 43, enters the second lens surface 142a of the second optical section 142 such that its optical axis is parallel to the central axis CA2 of the second lens surface 142a and does not coincide with the central axis CA2 of the second lens surface 142a, is emitted to converge toward the light-receiving element 30, and enters the light-receiving element 30. The feedback light L2 generated by reflecting the reception light L1 by the surface of the light-receiving element 30 travels while diffusing toward the second optical section, a portion of it passes through the second lens surface 142a, and the rest enters the feedback light suppression area 142b of the inclined base surface 142c. The feedback light entering the feedback light suppression area 142b is refracted according to an incident angle of the feedback light L2, the inclination angle θ, and a refractive index of the optical receptacle 140. Here, since it is inclined such that it is closer the light-receiving element 30 at a point farther away from the central axis CA2 of the second lens surface 142a in a direction opposite to the optical axis of the reception light L1, the feedback light L2 is refracted away from the central axis of the second lens surface. Thus, the feedback light entering the feedback light suppression area 142b does not reach the reflection surface 43 and is emitted from the top surface 4b of the optical receptacle 140. Therefore, the optical module 110 and the optical receptacle 140 of this embodiment can prevent the feedback light entering the feedback light suppression area 142b from reaching the first optical section 41, can also prevent it from reaching the end face 21 of the optical transmission body 20, and can even prevent it from reaching a light-emitting element not shown via the optical transmission body 20.

### Embodiment 1-3

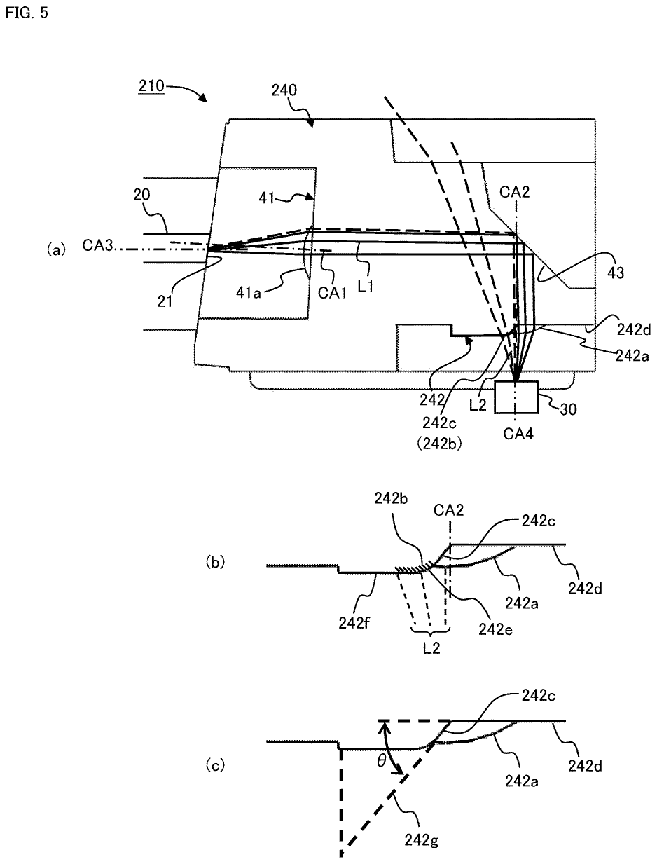

FIG. 5A is a schematic configuration view that shows an overview of another optical module 210 according to the first embodiment of the present invention along with a longitudinal cross-sectional view of an optical receptacle 240 according to this embodiment, FIG. 5B is an enlarged view of a second optical section 242 of the optical receptacle 240, and FIG. 5C is a reference view in which an inclined surface 242c is extended. The optical module 210 of this embodiment differs from that of Embodiment 1-1 only in configuration of s second optical section 242 and is otherwise the same as the optical module 10 of Embodiment 1-1, so a description thereof will be omitted.

As shown in FIGS. 5A and 5B, the second optical section 242 of this embodiment includes a second lens surface 242a and a feedback light suppression area 242b. As shown in FIG. 5C, and as in Embodiment 1-1, in this embodiment, the second lens surface 242a, which is the same curved surface as the conventional one, is formed to be continuous with a flat base surface 242d perpendicular to a central axis CA2 of the lens surface and/or a central axis CA4 of a light-receiving element 30 and an inclined base surface 242 c inclined by an angle θ (an angle of 90°-θ relative to a central axis CA2 of the second lens surface 242a) from the base surface. Beyond the inclined base surface 242c, a curved surface 242e and then a second base surface 242f that is flat or has a different inclination continue from an end of the second lens surface 242a. Here, as shown in FIG. 5B, feedback light L2 enters a portion of the curved surface 242e and a portion of the second base surface 242f from the left of the central axis CA2 of the second lens surface 242a of the second optical section 242, and an area (marked with diagonal lines) which the feedback light L2 enters but is not included in the second lens surface 242a is the feedback light suppression area 242b.

Although the inclined base surface 242c is inclined to the same direction as in Embodiments 1-1 and 1-2, in this embodiment, the inclined base surface 242c is smoothly connected, at a point where its height is the same as or slightly higher than that of the second lens surface 242a, to the curved surface 242e and then to the second base surface 242f. The curved surface 242e is a connecting portion that makes the inclined base surface 242c continuous with the second base surface 242f smoothly. The second base surface 242f is a plane or a curved surface. For example, it may be a plane perpendicular to the central axis CA2 of the second lens surface and/or the central axis CA4 of the light-receiving element 30, or an inclined surface (plane or curved surface) with an inclination angle smaller than the inclination angle θ of the inclined base surface 242c. As shown in FIG. 5C, if the inclined base surface 242 c is extended as it is, an extension line 242g (dotted line) will form a triangle with an acute tip. In particular, if the inclination angle θ of the inclined base surface is increased, the tip also becomes sharp. However, when molding a shape with an acute angle using a mold, filling of resin tends to be insufficient, which can lead to molding defects. In addition, if there is a protrusion such as that indicated by the extension line 242g (dotted line), it can interfere with other members on a substrate such as wire bonding. In this regard, these problems can be solved by transitioning the inclined base surface 242c to the second base surface 242f midway, as in this embodiment. Furthermore, the second optical section 242 of this embodiment allows for a larger inclination angle θ, which also has an effect of suppressing reflection.

As shown in FIG. 5A, in the optical module 210 of this embodiment, the reception light L1 obliquely emitted from an end face 21 of an optical transmission body 20 enters a first lens surface 41a of a first optical section 41, travels in the optical receptacle 240 as parallel light, is reflected by a reflection surface 43, enters the second lens surface 242a of the second optical section 242 such that its optical axis is parallel to the central axis CA2 of the second lens surface 242a and does not coincide with the central axis CA2 of the second lens surface 242a, is emitted to converge toward the light-receiving element 30, and enters the light-receiving element 30. The feedback light L2 generated by reflecting the reception light L1 by the surface of the light-receiving element 30 travels while diffusing toward the second optical section, a portion of it passes through the second lens surface 242a, and the rest enters the feedback light suppression area 242b. The feedback light entering the feedback light suppression area 242b is refracted according to an incident angle of the feedback light L2, the inclination angle θ, a curvature of the curved surface 242e, the inclination angle of the second base surface, and a refractive index of the optical receptacle 240. Here, since it is refracted in a direction farther away from the central axis CA2 of the second lens surface compared to refraction by the second lens surface 242a, it can be prevented from reaching the reflection surface 43 or the first optical section 41. Thus, the optical module 210 and the optical receptacle 240 of this embodiment can prevent the feedback light entering the feedback light suppression area 242b from reaching the end face 21 of the optical transmission body 20, and can even prevent it from reaching a light-emitting element not shown via the optical transmission body 20.

### Second Embodiment

### Embodiment 2-1

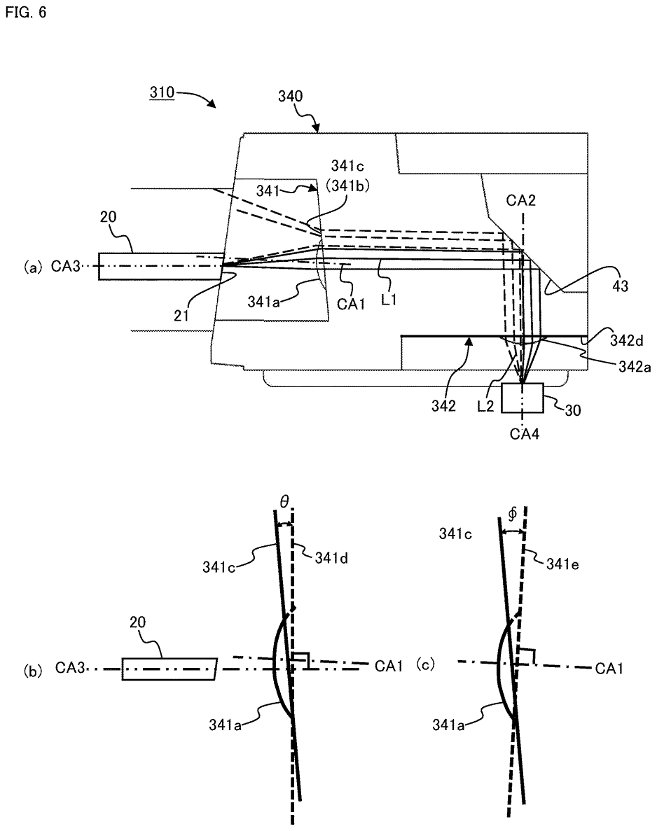

FIG. 6A is a schematic configuration view that shows an overview of an optical module 310 according to a second embodiment of the present invention along with a longitudinal cross-sectional view of an optical receptacle 340 according to this embodiment, and FIGS. 6B and 6C are views for illustrating a shape of a first lens surface 341a. The optical module 310 of this embodiment is implemented in a receiving section of a receiving optical module or a transmitting/receiving optical module, similarly to the first embodiment.

As shown in FIG. 6A, the optical module 310 is configured as follows: it includes an optical transmission body 20, a light-receiving element 30, and the optical receptacle 340; the optical receptacle 340 is arranged between the optical transmission body 20 and the light-receiving element 30; it allows reception light L1 emitted from an end face 21 of the optical transmission body 20 to enter the optical receptacle 340 via a first optical section 341 of the optical receptacle 340; and it allows the reception light that has traveled through the optical receptacle 340 to enter the light-receiving element 30 via a second optical section 342.

The optical transmission body 20 is similar to the optical transmission body of the first embodiment and emits the reception light L1 that has been transmitted via the optical transmission body 20 from the end face 21. A direction of an optical axis of the reception light L1 emitted from the end face of the end face 21 of the optical transmission body 20 can be appropriately set by an emission angle from the end face 21 and positioning relative to the optical receptacle 340. In FIG. 6A, the reception light L1 is emitted obliquely relative to a central axis CA3 (dashed double-dotted line) of the optical transmission body 20 and is incident obliquely above the central axis CA1 of the first lens surface. In this embodiment, since a feedback light suppression area 341b is formed on the first optical section 341 of the optical receptacle 340, an angle of the reception light emitted from the end face 21, an angle of the reception light entering the first optical section, etc., are not particularly limited as long as at least a part of an area on the first optical section 341 through which the reception light L1 passes does not overlap with an area through which its feedback light L2 passes. For example, the central axis CA3 (dashed double-dotted line) of the optical transmission body 20 may coincide with the optical axis of the reception light, or the optical axis of the reception light may coincide with the central axis CA1 of the first lens surface 341a.

The light-receiving element 30 is similar to that of the first embodiment, and the central axis CA4 of the light-receiving element 30 may be arranged to be parallel to a central axis CA2 of a second lens surface 342a of the second optical section 342 of the optical receptacle 340, or to be inclined relative to the central axis CA2. In order to prevent deformation of the beam shape of the reception light on the light-receiving element 30, etc., it is preferable that the central axis CA4 of the light-receiving element 30 is arranged to be parallel to the central axis CA2 of the second lens surface 342a, and the central axis CA4 of the light-receiving element 30 may coincide with the central axis CA2 of the second lens surface 42a.

The optical receptacle 340 of this embodiment has a function of emitting the reception light L1 emitted from the optical transmission body 20 toward the light-receiving surface of the light-receiving element 30 and differs from the optical receptacle of the first embodiment in configurations of the first optical section 341 and the second optical section 342. In this embodiment, the first optical section 341 includes the first lens surface 341a and the feedback light suppression area 341b, and the second optical section 342 is continuous with a flat base surface 342d similar to the conventional one to form a second lens surface 342a.

The first optical section 341 faces the end face 21 of the optical transmission body 20 and includes the first lens surface 341a that allows the reception light L1 emitted from the end face 21 of the optical transmission body 20 to enter the inside of the optical receptacle, and the feedback light suppression area 341b on at least a part of an area from which the feedback light generated by reflecting the reception light by the light-receiving element emits, the feedback light suppression area 341b being shaped such that at least a portion of the feedback light does not reach the end face of the optical transmission body. The first lens surface 341a is convex toward the end face 21 of the optical transmission body 20. The number and the arrangement of the first lens surface 341a correspond to those of the optical transmission body 20. The first lens surface 341a allows the reception light L1 emitted from the end face 21 of the optical transmission body 20 to enter the inside of the optical receptacle as parallel light.

In the conventional first optical section, the first lens surface as shown in FIG. 6B is formed to be continuous with a base surface 341d (dashed line) perpendicular to the central axis CA3 of the optical transmission body 20 and has the inclined central axis CA1, or the first lens surface as shown in FIG. 6C is formed to be continuous with a base surface 341e (dashed line) perpendicular to the central axis CA1 of the first lens surface. In contrast, in the first optical section 341 of this embodiment, as shown in FIG. 6B, the first lens surface 341a, which is the same curved surface as the conventional one, is formed to be continuous with an inclined base surface 341 c inclined by an angle θ relative to the conventional base surface 341d perpendicular to the central axis CA3 of the optical transmission body 20 (an angle of 90°-θ relative to the central axis CA3 of the optical transmission body 20). As shown in FIG. 6C, the inclined base surface 341c is inclined by an angle φ relative to the base surface 341e perpendicular to the central axis CA1 of the first lens surface, the angle φ being the sum of the angle θ and an angle formed by the central axis CA1 of the first lens surface and the central axis CA3 of the optical transmission body 20. As shown in FIGS. 6B and 6C, the first lens surface 341a of this embodiment is the same curved surface as the conventional one, and its central axis CA1 is also the central axis of the conventional lens surface.

The inclined base surface 341c is a plane or curved surface inclined relative to a plane orthogonal to the central axis CA3 of the optical transmission body 20, and the inclined plane or curved surface has an inclination such that an optical path length of the feedback light L2 from the light-receiving element 30 to the first optical section 341 is longer than an optical path length of the reception light L1 from the first optical section 341 to the light-receiving element 30. In addition, the inclined base surface 341c has an inclination such that, in a cross section including the central axis CA3 of the optical transmission body 20 and an optical axis of the feedback light L2, it is closer to the end face 21 of the optical transmission body 20 at a point farther away from the central axis CA1 of the first lens surface in a direction toward the optical axis of the feedback light L2 relative to the central axis CA1 of the first lens surface 341a. An area of the inclined base surface 341c where the feedback light L2 is incident functions as the feedback light suppression area 341 b. In this embodiment, the plane inclined by the angle θ relative to the conventional base surface 341d perpendicular to the central axis CA3 of the optical transmission body 20 and the angle φ relative to the base surface 341e perpendicular to the central axis CA1 of the first lens surface is the feedback light suppression area 341b. The angle θ of the inclined base surface 341 c can be from 10° to 45°.

As shown in FIG. 6A, the entire reception light L1 passes through the first lens surface 341a, but a portion of the feedback light L2 passes through the first lens surface 341a and the rest passes through the inclined base surface 341c. An area of the inclined base surface 341c through which the feedback light L2 passes is the feedback light suppression area 341b according to this embodiment. Due to its inclination, the feedback light suppression area 341b refracts and emits the feedback light in a direction away from the central axis CA3 of the optical transmission body 20 to generate light that travels away from the central axis CA3 of the optical transmission body 20. In the first optical section 341 of this embodiment, the lens has a nearly circular planar shape, and the lens position can be measured with high precision in the lens arrangement direction so that the lens position can be controlled with high precision.

The second optical section 342 includes the second lens surface 342a that focuses the reception light L1 emitted from the end face 21 of the optical transmission body 20 and entering the optical receptacle via the first optical section 341 onto the light-receiving element 30. The second lens surface 342a of this invention is the lens surface as the conventional one that is symmetrical relative to the central axis of the second lens surface 342a. In this embodiment, the second lens surface 342a is arranged such that the central axis CA2 of the second lens surface does not coincide with the optical axis of the reception light L1. Specifically, the central axis CA2 of the second lens surface 342a is arranged to be inclined relative to the optical axis of the reception light L1 or is arranged such that the central axis CA2 of the second lens surface 342a is parallel to but does not coincide with the optical axis of the reception light L1.

As shown in FIG. 6A, in the optical module 310 of this embodiment, the reception light L1 obliquely emitted from the end face 21 of the optical transmission body 20 enters the first lens surface 341a of the first optical section 341, travels in the optical receptacle 340 as parallel light, is reflected by the reflection surface 43, enters the second lens surface 342a of the second optical section 342 such that its optical axis is parallel to the central axis CA2 of the second lens surface 342a and does not coincide with the central axis CA2 of the second lens surface 342a, and is emitted to converge toward the light-receiving element 30, and the reception light L1 enters the light-receiving element 30. The feedback light L2 generated by reflecting the reception light L1 by the surface of the light-receiving element 30 travels while diffusing toward the second optical section, enters the second lens surface 342a, travels in the optical receptacle 340 as parallel light, is reflected by the reflection surface 43, and travels toward the first optical section 341. A portion of the feedback light L2 enters the first lens surface 341a, while the rest enters the feedback light suppression area 341b formed by the inclined base surface 341c, and the feedback light is refracted and emitted in a direction away from the central axis CA3 of the optical transmission body 20. Thus, the optical module 310 and the optical receptacle 340 of this embodiment can prevent the feedback light entering the feedback light suppression area 341b from reaching the end face 21 of the optical transmission body 20, and can even prevent it from reaching a light-emitting element not shown via the optical transmission body 20.

### Embodiment 2-2

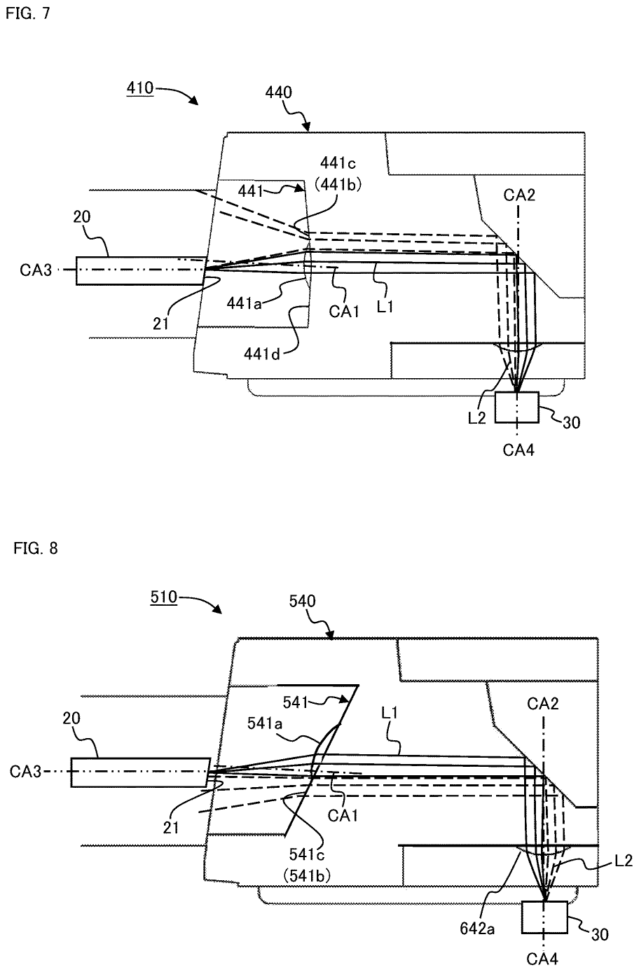

FIG. 7 is a schematic configuration view that shows an overview of another optical module 410 according to the second embodiment of the present invention along with a longitudinal cross-sectional view of an optical receptacle 440 according to this embodiment. The optical module 410 of this embodiment differs from that of Embodiment 2-1 only in configuration of a first optical section 341 and is otherwise the same as the optical module 310 of Embodiment 2-1, so a description thereof will be omitted.

As shown in FIG. 7, the first optical section 441 of this embodiment includes: a first lens surface 441a; an inclined base surface 441c that has an inclination such that, similarly to the inclined base surface 341 c of the Embodiment 2-1, an optical path length of feedback light L2 from a light-receiving element 30 to the first optical section 441 is longer than an optical path length of reception light L1 from the first optical section 441 to the light-receiving element 30; and a second plane or curved surface 441d that is different from the inclined base surface 441c and is perpendicular to a central axis CA1 of the first lens surface 441a, is perpendicular to a central axis CA3 of an optical transmission body 20, or inclined at an opposite inclination to that of the inclined base surface 441c. Here, a part of the first lens surface 441a is formed to be continuous with the inclined base surface 441c, while another part of the first lens surface 441a is formed to be continuous with the second plane or curved surface 441d.

The inclined base surface 441c is a plane or curved surface inclined relative to a plane orthogonal to the central axis CA3 of the optical transmission body 20 and has an inclination such that, in a cross section including the central axis CA3 of the optical transmission body 20 and an optical axis of the feedback light L2, it is closer to the end face 21 of the optical transmission body 20 at a point farther away from the central axis CA1 of the first lens surface in a direction toward the optical axis of the feedback light L2 relative to the central axis CA1 of the first lens surface 441a. An area of the inclined base surface 441c where the feedback light L2 is incident functions as the feedback light suppression area 441 b. In this embodiment, the plane inclined by the angle θ relative to the conventional base surface 341d perpendicular to the central axis CA3 of the optical transmission body 20 and the angle φ relative to the base surface 341e perpendicular to the central axis CA1 of the first lens surface is the feedback light suppression area 441b.

The second plane or curved surface 441d may be a plane or a curved surface, and it is a plane perpendicular to the central axis CA1 of the first lens surface 441a, a plane perpendicular to the central axis CA3 of the optical transmission body 20, or a plane or curved surface inclined at an opposite inclination to that of the inclined base surface 441c. The opposite inclination refers to, for example in FIG. 6B, an inclination with a negative angle (angle range is 0 to 90°) relative to the base surface 341 d perpendicular to the central axis CA3 of the optical transmission body 20 when an inclination angle θ is assumed to be positive. Also, in FIG. 6C, it refers to an inclination with a negative angle (angle range is 0 to 90°) relative to the base surface 341 e perpendicular to the central axis CA1 of the first lens surface. The second plane or curved surface 441d is arranged closer to the optical axis of the reception light L1 than the feedback light suppression area 441b (on the opposite side of the optical axis of the feedback light relative to the central axis CA1) (lower side in FIG. 7).

The optical path of the feedback light of this embodiment is similar to that of Embodiment 2-1, and thus the feedback light entering the feedback light suppression area 441b formed by the inclined base surface 441c is refracted and emitted in a direction away from the central axis CA3 of the optical transmission body 20 so that it can be prevented from reaching the end face 21 of the optical transmission body 20, and it can be even prevented from reaching a light-emitting element not shown via the optical transmission body 20. This embodiment can be adapted to a case where the inclination angle of the inclined base surface 441c is large and can reduce influence on flowability of resin into a mold and releasability from a mold. That is, the inclined base surface constitutes an inner bottom surface of a first recess 45 of the optical receptacle, and if the entire inner bottom surface is made as the inclined base surface as in Embodiment 2-1 (FIG. 6A), it comes closer to a second recess 46 formed on a bottom surface 4a and a rear surface 4f of the optical receptacle 40 as the inclination angle becomes larger, which can cause problems such as insufficient filling of resin into a mold, and likelihood of breakage when removed from a mold. These drawbacks can be reduced by providing the second plane or curved surface 441d as in this embodiment.

### Embodiment 2-3

FIG. 8 is a schematic configuration view that shows an overview of another optical module 510 according to the second embodiment of the present invention along with a longitudinal cross-sectional view of an optical receptacle 540 according to this embodiment. The optical module 510 of this embodiment differs from that of Embodiment 2-1 in configuration of a first optical section 541 and optical paths of reception light L1 and feedback light L2, with the reception light L1 incident on the left side of a second lens surface 542a and the feedback light incident on the right side of the second lens surface 542a. Therefore, the feedback light L2 that has traveled in the optical receptacle 540 reaches the first optical section 541 below the reception light L1. An inclined base surface 541c of the first optical section 541 is a plane or curved surface inclined relative to a plane orthogonal to a central axis CA3 of an optical transmission body 20 and has an inclination such that an optical path length of the feedback light L2 from a light-receiving element 30 to the first optical section 541 is longer than an optical path length of the reception light L1 from the first optical section 541 to the light-receiving element 30. Therefore, in FIG. 8, it is inclined such that it is closer to an end face 21 of an optical transmission body 20 as it goes downward. An area of the inclined base surface 541c where the feedback light L2 is incident functions as a feedback light suppression area 541b and refracts the entered return light away from the central axis CA3 of the optical transmission body 20.

### Embodiment 2-4

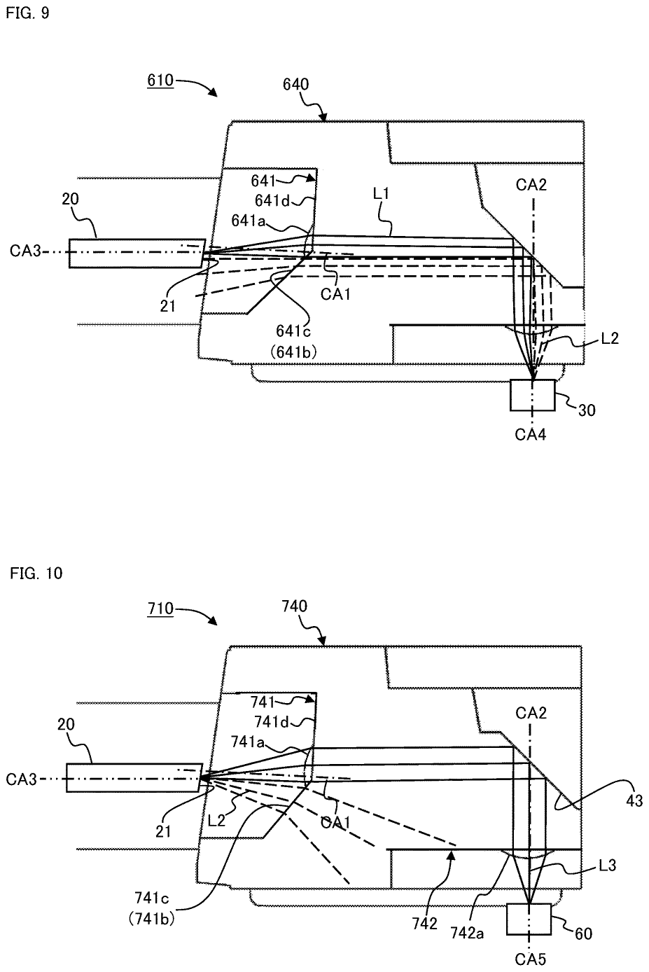

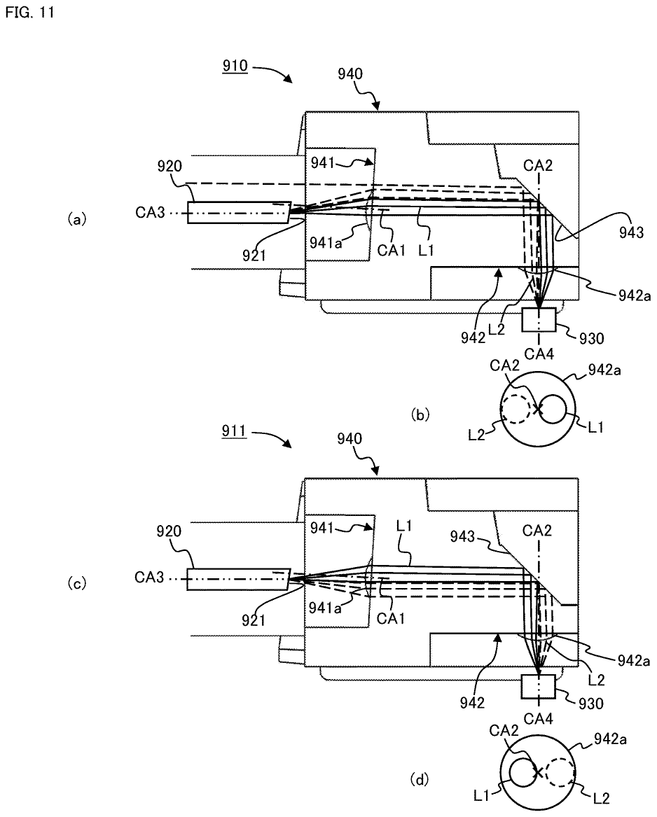

FIG. 9 is a schematic configuration view that shows an overview of another optical module 610 according to the second embodiment of the present invention along with a longitudinal cross-sectional view of an optical receptacle 640 according to this embodiment. The optical module 610 of this embodiment is configured by adding a second plane or curved surface 641d to the first optical section 541 of Embodiment 2-3. The second plane or curved surface 641d may be a plane or a curved surface, and it is a plane perpendicular to a central axis CA1 of a first lens surface 641a, a plane perpendicular to a central axis CA3 of an optical transmission body 20, or a plane or curved surface inclined at an opposite inclination to that of an inclined base surface 641c. In FIG. 9, the plane 641d perpendicular to the central axis CA3 of the optical transmission body 20 is arranged closer to an optical axis of reception light L1 than a feedback light suppression area 641b (on the opposite side of an optical axis of the feedback light relative to the central axis CA1) (upper side in FIG. 9). Also in this embodiment, as in Embodiment 2-3, an area of the inclined base surface 641c where the feedback light L2 is incident functions as the feedback light suppression area 641b and refracts the entered return light away from the central axis CA3 of the optical transmission body 20.

### Third Embodiment

FIG. 10 is a schematic configuration view that shows an overview of an optical module 710 according to the third embodiment of the present invention along with a longitudinal cross-sectional view of an optical receptacle 740 according to this embodiment. The optical module 710 of this embodiment is implemented in a transmitting section of a transmitting optical module or a transmitting/receiving optical module.

As shown in FIG. 10, the optical module 710 is configured as follows: it includes an optical transmission body 20, a light-emitting element 60, and the optical receptacle 740; the optical receptacle 740 is arranged between the optical transmission body 20 and the light-emitting element 60; it allows transmission light L3 emitted from a light-emitting surface of the light-emitting element 60 to enter the optical receptacle 740 via a second optical section 742 of the optical receptacle 740; and it allows the transmission light that has traveled through the optical receptacle 740 to enter an end face 21 of the optical transmission body 20 via a first optical section 741.

The optical transmission body 20 is similar to the optical transmission body of the first embodiment, but it is on the transmitting side so that it allows the transmission light L3 emitted from the light-emitting element 60 to enter the end face 21 and transmits it to the other end face (the receiving side). The end face 21 of the optical transmission body 20 reflects a portion of the transmission light L3 to generate feedback light LA.

The light-emitting element 60 is a vertical cavity surface emitting laser (VCSEL), a light-emitting diode, a laser diode, or the like, for example. The number of the light-emitting element 60 is not particularly limited and selected according to the configuration of the optical receptacle 740. The light-emitting element 60 may be implemented on a substrate not shown. A central axis CA5 of the light-emitting element 60 may be arranged to be parallel to the normal to the surface of the substrate, or to be inclined relative to the normal. For ease of installation and alignment with the optical receptacle, it is preferable to the central axis CA5 of the light-emitting element 60 is arranged to be parallel to the normal to the surface of the substrate. It should be noted that the central axis CA5 of the light-emitting element 60 refers to the normal to a light-emitting surface of the light-emitting element 60 passing through the center of the light-emitting surface.

The optical receptacle 740 of this embodiment has a function of emitting the transmission light L3 emitted from the light-emitting element 60 toward the end surface 21 of the optical transmission body 20. Although it differs from the optical receptacle 40 of the first embodiment in that the former is for transmission while the latter is for reception, both have the similar basic configurations. The optical receptacle 740 has at least the first optical section 741 arranged on the front surface 4e side and the second optical section 742 arranged on the bottom surface 4a side. Furthermore, in this embodiment, it has a reflection surface 43 and a ferrule-matching convex part 44.

The first optical section 741 faces the end face 21 of the optical transmission body 20 and includes: the first lens surface 741a that allows the transmission light L3 emitted from the light-emitting element 60 and entering the optical receptacle 740 via the second optical section 742 to enter the end face 21 of the optical transmission body 20; and a feedback light suppression area 741b on at least a part of an area which the feedback light LA generated by reflecting the transmission light L3 by the end face 21 of the optical transmission body enters, the feedback suppression area 741b being shaped such that at least a portion of the feedback light does not reach the light-emitting element 60. The first lens surface 741a is convex toward the end face 21 of the optical transmission body 20. According to this embodiment, the first lens surface 741a is arranged such that a central axis CA1 of the first lens surface 741a does not coincide with an optical axis of the transmission light L3 so that at least a part of an area on the first optical section 741 through which the transmission light L3 passes does not overlap with an area through which its feedback light L4 passes. The number and the arrangement of the first lens surface 741a correspond to those of the optical transmission body 20. The first lens surface 741a focuses the transmission light L3, which has traveled through the optical receptacle, onto the end face 21 of the optical transmission body 20.

The first optical section 741 of this embodiment has a similar shape to that of the first optical section 641 of Embodiment 2-4 (FIG. 9) and includes an inclined base surface 741c, and a second plane or curved surface 741d that is different from the inclined base surface 741c. Here, a part of the first lens surface 741a is formed to be continuous with the inclined base surface 741c, while another part of the first lens surface 741a is formed to be continuous with the second plane or curved surface 741d. The inclined base surface 741c is a plane or curved surface inclined relative to a plane orthogonal to a central axis CA3 of the optical transmission body 20 and has an inclination such that an optical path length of the feedback light L4 from the end face 21 of the optical transmission body to the first optical section 741 is shorter than an optical path length of the transmission light L3 from the first optical section 741 to the end face 21 of the optical transmission body. In addition, the inclined base surface 741c has an inclination such that, in a cross section including the central axis CA3 of the optical transmission body 20 and an optical axis of the feedback light LA, it is closer to the end face 21 of the optical transmission body 20 at a point farther away from the central axis CA1 of the first lens surface in a direction toward the optical axis of the feedback light L4 relative to the central axis CA1 of the first lens surface 741a. An area of the inclined base surface 741c where the feedback light LA is incident functions as the feedback light suppression area 741b. The second plane or curved surface 741d may be a plane or a curved surface, and it is a plane perpendicular to the central axis CA1 of the first lens surface 441a, a plane perpendicular to the central axis CA3 of the optical transmission body 20, or a plane or curved surface inclined with an opposite inclination to that of the inclined base surface 441c. The opposite inclination refers to an inclination with a negative angle (angle range is 0 to 90°) when an inclination angle θ of the inclined base surface relative to a certain surface is assumed to be positive.

The second optical section 742 faces the light-emitting element 60 and has an optical surface that allows the transmission light L3 emitted from the light-emitting element 60 to enter the inside of the optical receptacle. The shape of the optical surface of the second optical section 742 is not particularly limited and may be a convex lens surface that is convex toward the light-emitting element 60, a concave lens surface that is concave toward the light-emitting element 60, or a plane. In this embodiment, the second optical section 742 has a second lens surface 742a that is convex toward the light-emitting element 60. The planar shape of the second lens surface 742a is not particularly limited and may be a circular shape or an elliptical shape. In this embodiment, the planar shape of the second lens surface 742a is a circular shape. The number and the arrangement of the second lens surface 742a correspond to those of the light-emitting element 60. The second lens surface 742a allows the transmission light L3 emitted from the light-emitting element 60 to enter the inside of the optical receptacle as parallel light. In this embodiment, a central axis CA2 of the second lens surface may or may not coincide with the central axis CA5 of the light-emitting element 60. In addition, the central axis CA2 of the second lens surface may or may not coincide with the optical axis of the transmission light L3.

As shown in FIG. 10, in the optical module 710 of this embodiment, the transmission light L3 emitted from the light-emitting surface of the light-emitting element 60 enters the second lens surface 742a of the second optical section 742, travels in the optical receptacle 740 as parallel light, is reflected by a reflection surface 43, enters the first lens surface 741a of the first optical section 741 such that its optical axis does not coincide with the central axis CA1 of the first lens surface 741a, is emitted to converge toward the end surface 21 of the optical transmission body 20, and enters the end surface 21 of the optical transmission body 20. The feedback light LA generated by reflecting the transmission light L3 by the end surface 21 of the optical transmission body 20 travels while diffusing toward the first optical section 741, and at least a portion of it enters the feedback light suppression area 742b of the inclined base surface 742c. The feedback light entering the feedback light suppression area 742b is refracted according to an incident angle of the feedback light L4, the inclination angle θ, and a refractive index of the optical receptacle 740. Here, since it is inclined such that it is closer to the end surface 21 of the optical transmission body 20 at a point farther away from the central axis CA1 of the first lens surface in a direction opposite to the optical axis of the feedback light L4 relative to the central axis CA1 of the first lens surface 741a, light is generated which travels away from the central axis CA3 of the optical transmission body 20. Thus, the feedback light entering the feedback light suppression area 742b does not reach the reflection surface 43 so that the amount of the feedback light that reaches the light-emitting element 60.

### REFERENCE SIGNS LIST

10 Optical Module
20 Optical Transmission Body
30 Light-Receiving Element
40 Optical Receptacle
41 First Optical section
41a First Lens Surface
42 Second Optical section
42a Second Lens Surface
42b Feedback Light Suppression Area
42c Inclined Base Surface
42d Flat Base Surface
L1 Reception Light
L2 Feedback Light
CA1 Central Axis of First Lens Surface
CA2 Central Axis of Second Lens Surface
CA3 Central Axis of Optical Transmission Body
CA4 Central Axis of Light-Receiving Element

1. An optical module comprising an optical transmission body, a light-receiving element, and an optical receptacle that is arranged between the optical transmission body and the light-receiving element and allows reception light emitted from an end face of the optical transmission body to enter the light-receiving element, wherein
the optical receptacle comprises:
a first optical section facing the end face of the optical transmission body; and
a second optical section facing the light-receiving element,
the second optical section comprises a second lens surface that focuses the reception light emitted from the end face of the optical transmission body and entering the optical receptacle via the first optical section onto the light-receiving element,
the second lens surface is arranged such that a central axis of the second lens surface does not coincide with an optical axis of the reception light, and wherein
(1) the second optical section further comprises a feedback light suppression area on at least a part of an area where feedback light generated by reflecting the reception light by the light-receiving element is incident, the feedback light suppression area being shaped such that at least a portion of the feedback light does not reach the first optical section; or
(2) the second optical section further comprises an inclined surface inclined relative to a plane orthogonal to a central axis of the light-receiving element, the inclined surface has an inclination such that, in a cross section including the central axis of the light-receiving element and the optical axis, the inclined surface is closer to the light-receiving element at a point farther away from the central axis of the second lens surface in a direction opposite to the optical axis relative to the central axis of the second lens surface, and at least a portion of the second lens surface is continuous with the inclined surface.

2. The optical module according to claim 1, wherein the feedback light suppression area comprises:
a plane that is inclined relative to a plane orthogonal to the central axis of the light-receiving element at an inclination such that an optical path length of an optical axis of the feedback light from the light-receiving element to the second optical section is shorter than an optical path length of the optical axis of the reception light from the second optical section to the light-receiving element; or
a curved surface by which the optical path length of the optical axis of the feedback light from the light-receiving element to the second optical section is shorter than the optical path length of the optical axis of the reception light from the second optical section to the light-receiving element.

3. The optical module according to claim 1, wherein the feedback light suppression area comprises a plane perpendicular to the central axis of the light-receiving element.

4. (canceled)

5. The optical module according to claim 1, wherein
the second optical section further comprises a plane perpendicular to the central axis of the light-receiving element, and
a portion of the second lens surface is continuous with the perpendicular plane.

6. An optical module comprising an optical transmission body, a light-receiving element, and an optical receptacle that is arranged between the optical transmission body and the light-receiving element and allows reception light emitted from an end face of the optical transmission body to enter the light-receiving element, wherein
the optical receptacle comprises:
a first optical section facing the end face of the optical transmission body; and
a second optical section facing the light-receiving element,
the first optical section comprises a first lens surface that allows the reception light emitted from the end face of the optical transmission body to enter the optical receptacle,
the second optical section comprises a second lens surface that focuses the reception light entering the optical receptacle via the first lens surface onto the light-receiving element,
the second lens surface is arranged such that a central axis of the second lens surface does not coincide with an optical axis of the reception light, and
the first optical section further comprises a feedback light suppression area on at least a part of an area from which feedback light generated by reflecting the reception light by the light-receiving element is emitted, the feedback light suppression area being shaped such that at least a portion of the feedback light does not reach the end face of the optical transmission body.

7. The optical module according to claim 6, wherein the feedback light suppression area comprises:
a plane that is inclined relative to a plane orthogonal to the central axis of the optical transmission body at an inclination such that an optical path length of the feedback light from the light-receiving element to the first optical section is longer than an optical path length of the reception light from the first optical section to the light-receiving element; or
a curved surface by which the optical path length of the feedback light from the light-receiving element to the first optical section is longer than the optical path length of the reception light from the first optical section to the light-receiving element.

8. The optical module according to claim 6, wherein the feedback light suppression area comprises:
a plane that is inclined relative to a plane orthogonal to the central axis of the optical transmission body at an inclination such that, in a cross section including the central axis of the optical transmission body and the optical axis of the feedback light, the plane is closer to the end face of the optical transmission body at a point farther away from the central axis of the first lens surface in a direction toward the optical axis of the feedback light relative to the central axis of the first lens surface; or
a curved surface which, in a cross section including the central axis of the optical transmission body and the optical axis of the feedback light, is closer to the end face of the optical transmission body at a point farther away from the central axis of the first lens surface in the direction toward the optical axis of the feedback light relative to the central axis of the first lens surface.

9. An optical module comprising an optical transmission body, a light-emitting element, and an optical receptacle that allows transmission light emitted from the light-emitting element to enter an end face of the optical transmission body, wherein
the optical receptacle comprises:
a first optical section facing the end face of the optical transmission body; and
a second optical section facing the light-emitting element,
the first optical section comprises a first lens surface that allows the transmission light emitted from the light-emitting element and entering the optical receptacle via the second optical section to enter the end face of the optical transmission body,
the first lens surface is arranged such that a central axis of the first lens surface does not coincide with an optical axis of the transmission light, and
the first optical section further comprises a feedback light suppression area on at least a part of an area where feedback light generated by reflecting the transmission light by the end face of the optical transmission body is incident, the feedback light suppression area being shaped such that at least a portion of the feedback light does not reach the light-emitting element.

10. The optical module according to claim 9, wherein the feedback light suppression area comprises:
a plane that is inclined relative to a plane orthogonal to the central axis of the optical transmission body at an inclination such that an optical path length of the feedback light from the end face of the optical transmission body to the first optical section is shorter than an optical path length of the transmission light from the first optical section to the end face of the optical transmission body; or
a curved surface by which the optical path length of the feedback light from the end face of the optical transmission body to the first optical section is shorter than the optical path length of the transmission light from the first optical section to the end face of the optical transmission body.

11. The optical module according to claim wherein the feedback light suppression area is an area that refracts light away from the central axis of the optical transmission body.

12. The optical module according to claim wherein
the first optical section further comprises a second surface different from the inclined plane or curved surface, the second surface being perpendicular to the central axis of the first lens surface, perpendicular to the central axis of the optical transmission body, or inclined at an inclination opposite to the inclined plane or curved surface, and
a portion of the first lens surface is continuous with the second surface.

13. An optical receptacle used in the optical module according to claim 1.

14. The optical module according to claim 9, wherein the feedback light suppression area is an area that refracts light away from the central axis of the optical transmission body.

15. The optical module according to claim 8, wherein
the first optical section further comprises a second surface different from the inclined plane or curved surface, the second surface being perpendicular to the central axis of the first lens surface, perpendicular to the central axis of the optical transmission body, or inclined at an inclination opposite to the inclined plane or curved surface, and
a portion of the first lens surface is continuous with the second surface.

16. The optical module according to claim 10, wherein
the first optical section further comprises a second surface different from the inclined plane or curved surface, the second surface being perpendicular to the central axis of the first lens surface, perpendicular to the central axis of the optical transmission body, or inclined at an inclination opposite to the inclined plane or curved surface, and
a portion of the first lens surface is continuous with the second surface.

17. An optical receptacle used in the optical module according to claim 6.

18. An optical receptacle used in the optical module according to claim 9.
